(19) United States
(12) Patent Application Publication
(10) Pub. No.: US 2006/0282536 A1
(43) Pub. Date: Dec. 14, 2006

(54) System and method for multi-channel email communication

(75) Inventors: Laird Popkin, West Orange, NJ (US); Yaron Samid, New York, NY (US); Paul Davies, Brooklyn, NY (US)

Correspondence Address: Ryan, Mason & Lewis, LLP, 1300 Post Road, Suite 205, Fairfield, CT, 06824, US

(73) Assignee: Pando Networks, Inc

(21) Appl. No.: 11/150,532

(22) Filed: Jun. 11, 2005

(51) Int. Cl. G06F 15/173

(52) U.S. Cl. 709/226

(57) ABSTRACT

A method of sending content via email includes the steps of creating an email message, obtaining a list of files and directories, selecting one or more files or directories to send as attachments, determining an appropriate channel by which to send the attachments, packaging the attachments into a package, removing the attachment from said email message and replacing said attachment with a link to said package, and sending the email message to one or more recipients, wherein the package is sent separately from the body of the email message via one or more alternative channels. The one or more alternative channels comprise a peer-to-peer swarming network.

### CROSS REFERENCE TO RELATED UNITED STATES APPLICATIONS

Reference is hereby made to these inventors' copending patent applications, U.S. patent application Ser. No. ______, entitled “Method And Apparatus For Offline Cooperative File Distribution Using Cache Nodes,” filed Jun. 3, 2005, and U.S. patent application Ser. No. ______, entitled “Method And Apparatus For Cooperative File Distribution In The Presence Of Firewalls”, filed Jun. 3, 2005, the contents of both of which are incorporated herein by references in their entirety.

### FIELD OF THE INVENTION

This invention is directed toward supporting push-oriented peer-to-peer swarming networking, including but not limited to rich-client and thin-client-based systems, to allow for more than one mode of information transmission for email data.

### BACKGROUND OF THE INVENTION

Conventional email systems send content via a single network and use standard Internet protocols including POP, IMP and SMTP. Conventional email systems have limitations with regard to content that can be transmitted, such as not supporting large files as attachments. Multi-channel email communication can be viewed as an automation of what power-users of the Internet with sufficient technical resources can already do. A sophisticated user of Internet technology can set up an FTP site with proper access controls and send an email telling an individual where they can retrieve a large file. Newer technology, such as a streaming server or a BitTorrent peer-to-peer server, can be used in place of FTP as a way to provide an alternative channel. Each of these technologies is a manual equivalent of multi-channel email communication. However, many people lack the knowledge or infrastructure to manually send large attachments to one or more receivers.

### SUMMARY OF THE INVENTION

The embodiments of the invention herein disclosed are directed to detaching and sending content, for example attachments, via an alternative channel of communication. The methods disclosed herein can be applied to very large files, confidential information and information that must arrive rapidly or efficiently at its destination or destinations. These methods are further applicable to rich clients, thin clients, or a combination where the sender is using one type of system and the receivers are using the other.

The automation described here makes it practical to send large attachments to one or more receivers. The embodiments of the invention can involve a little automation to a great deal of automation for the sender and, likewise, a small amount to a large amount of automation for the receiver.

A small amount of automation for the sender can involve simply providing instructions on how to put a large file on a server or into a peer-to-peer swarming network while making it transparent to the user initiating the send operation. A high degree of automation can involve allowing the sender to perform the activities to which they are accustomed, from supporting both drag and drop and using a file-finder dialog to identifying the files that need to be sent.

A small amount of automation for the receiver can involve simply supporting a special file extension so that when that file is clicked on, downloading starts immediately. A high degree of automation can involve identifying interesting things to be downloaded and beginning the download even when the receiving user is busy doing other things and unaware of the arrival of a message or its attachments.

Differing levels of automation of multi-channel email communication is one way that embodiments of the invention can be distinguished from one another. Another distinction is how multi-channel content is identified while in transit from sending machine to receiving machine. One could send ID numbers, URLs or executable files that contain the information needed for the receiver to obtain the information. One could also employ peer-to-peer swarming technology, such as a meta-data definition file such as a BitTorrent torrent file, or a reference, such as a URL, that could be used to access to a definition file stored on a server.

The technology underlying the embodiments of the invention disclosed herein form the subject matter of these inventors' copending patent applications, U.S. patent application Ser. ______, entitled “Method And Apparatus For Offline Cooperative File Distribution Using Cache Nodes,” and U.S. patent application Ser. No. ______, entitled “Method And Apparatus For Cooperative File Distribution In The Presence Of Firewalls.

### BRIEF DESCRIPTION OF THE DRAWINGS

FIG. 1 is a use case diagram of a system according to an embodiment of the invention.

FIG. 2 depicts a class diagram illustrating the architecture of a system according to an embodiment of the invention.

FIG. 3 depicts a sequence diagram illustrating a rich client sending an email attachment via a file browser, according to an embodiment of the invention.

FIG. 4 depicts a sequence diagram of a rich-client email sending an attachment via drag and drop, according to an embodiment of the invention.

FIG. 5 depicts a sequence diagram illustrating a thin client sending an email attachment via a file browser, according to an embodiment of the invention.

FIG. 6 is a sequence diagram illustrating the actions that occur when a desirable multi-channel email arrives with the use of a thin-client notifier, according to an embodiment of the invention.

FIG. 7 is a sequence diagram illustrating the arrival of multi-channel non-interesting email.

FIG. 8 is a sequence diagram illustrating the actions that occur when a desirable multi-channel email arrives at a rich client.

FIG. 9 is a use case illustrating an automated large-file communications management system, according to an embodiment of the invention.

FIG. 10 depicts a use case illustrating viral marketing as a result of “large file lock.”

FIG. 11 depicts a diagram illustrating how an existing client email program becomes part of a larger module, exposing a new Application Programmer Interface (API).

FIG. 12 depicts the architecture of an embodiment of an embedded multi-channel email communication system in which the features described herein above are embedded in a Rich Client Email Program

FIG. 13 depicts the components of an implementation of a network shim multi-channel email communication, according to an embodiment of the invention.

FIG. 14 depicts the components diagram of a local POP and SMTP implementation, according to an embodiment of the invention.

FIG. 15 is a flow chart illustrating the process of receiving email, according to an embodiment of the invention.

FIG. 16 is a flow chart illustrating multi-step attach activity, according to an embodiment of the invention.

FIG. 17 is a schematic diagram of an automation scatter plot, illustrating that automation of multi-channel communication can occur at many different levels.

### DETAILED DESCRIPTION OF THE PREFERRED EMBODIMENTS

Terminology

Pull-oriented electronic communication: A method of communication that involves the data-receiving user initiating the requesting of information. Technologies include web browsing, FTP downloading, and P2P search networks such as Gnutella and KaZaA/FastTrack.

Push-oriented electronic communication: A method of communication based on technologies where a properly configured machine receives content without the user having to act to obtain it. These technologies include email, instant messaging, Channel Definition Format (CDF), Really Simple Syndication (RSS) format or Information and Content Exchange (ICE) Protocol.

Thin-Client Email: Browser-based email services from a website such as hotmail.com, gmail.com or yahoo.com.

Rich-Client Email: A classic email client such as Eudora, Microsoft Outlook and Outlook Express that can pull email messages and content from an email server and send messages to others via an email server.

Asynchronous Activities: Activities, such as sending an email, where a user does not have to wait for the activity to complete before moving on to the next task and/or where activities do not occur simultaneously.

Peer-to-peer Swarming: A technology for delivering large files, such as large video files, as many digital “chunks”. With swarming, small chunks of the file are simultaneously downloaded from different hosts, which can include desktop computers of consumers, and re-assembled to form a whole file. This technique creates an extremely efficient “virtual large pipe” that allows content providers to allocate fewer servers and reduce dedicated network resources, thus reducing distribution and administrative costs.

Multi-Channel Email System: An email system in which content is sent, at least in part, by one or more alternative channels, such as a peer-to-peer swarming network.

Large File Lock: The desire to share one or more large files while lacking a rapid, inexpensive means of sharing or a means of sharing at all.

Email Rules: Many email clients such as Outlook include the ability to run user-created rules, which can be used to, for example, place emails from a particular co-worker into a special folder.

Email Protocols: A set of standard rules for data representation, signaling, authentication, and error detection required to send information over a communications channel for the purpose of sending and/or receiving email. Some examples of email protocols include SMTP, POP, IMAP, and MIME.

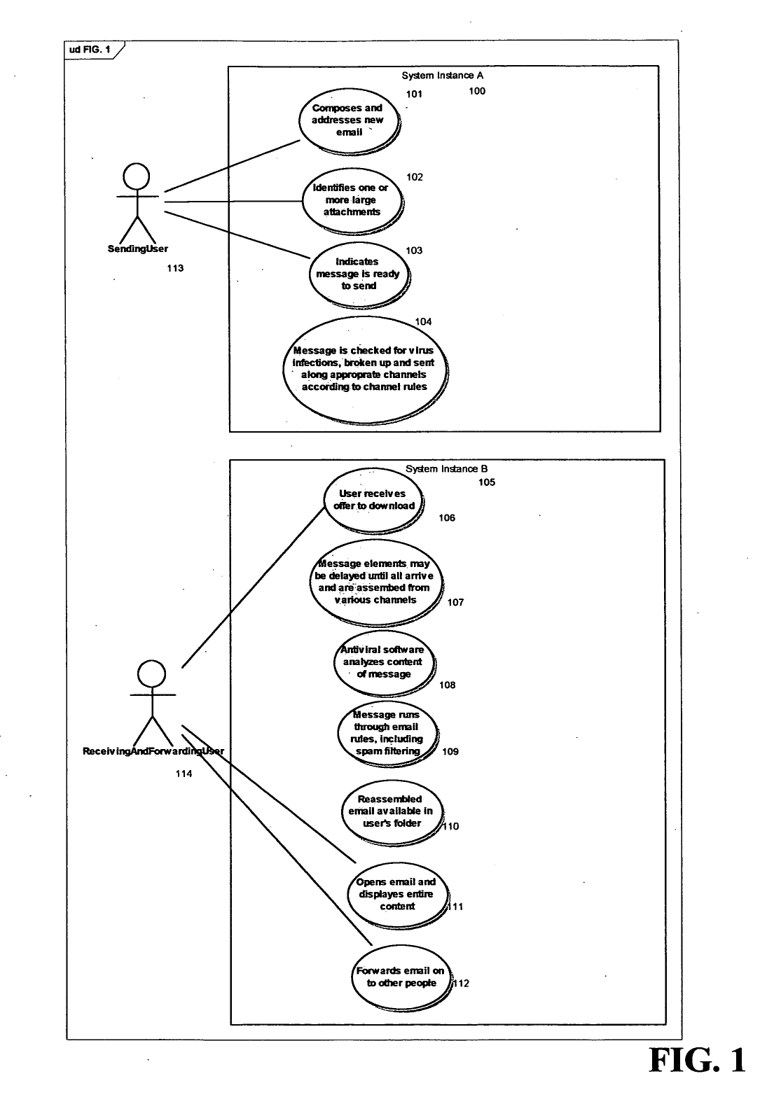

FIG. 1 is a use case diagram of a system according to an embodiment of the invention. This diagram illustrates that the users, both the SendingUser 113, a person employing some sort of networked computing device such as a PC, and the ReceivingAndForwardingUser 114, another person employing some sort of networked computing device, can proceed normally when using email systems to access the alternative channels described herein. In addition to eliminating the need for user training, this system supports interoperability of multi-channel email system instances. System Instance A 100 could be web-based email, such as Yahoo, while System Instance B 105 could be a rich-client system, such as Microsoft Outlook Express.

In an exemplary usage of this embodiment, SendingUser 113 in System Instance A 100 composes 101 an email message, attaches 102 additional files and sends 103, perhaps by clicking on a send button, as is normal for email users. The system 100 employs business logic to determine how the message should actually be sent 104 to its destination or destinations. SendingUser 113 need not explicitly decide which elements of the email will travel via which channel.

Elements of the mail sent by SendingUser 113 will generally arrive in System Instance B 105 over a period of time. System Instance B 105 can, but need not, show an offer 106 to the user to download the attachment(s). It can employ a rule or set of rules to determine if the content is to be retrieved. The system can delay 107 the visibility of the email elements until all have arrived and are assembled, which may involve the NetworkPackage 201 from the attachments area of an email seeking out the items referenced by those marker or identifier files. Next, the conventional processes that ReceivingAndForwardingUser 114 would expect are performed, including the running of antiviral software 108, email system rules 109 to classify emails into various folders, and spam filtering. When the email is made visible 110 in the user's folder, it can be fully reconstituted, as though it had traveled along the normal email channel. Alternatively, a link or a meta file can be presented that provides access to the content. ReceivingAndForwardingUser 114 can open it as normal 111, manipulate it and even forward it on to others 112.

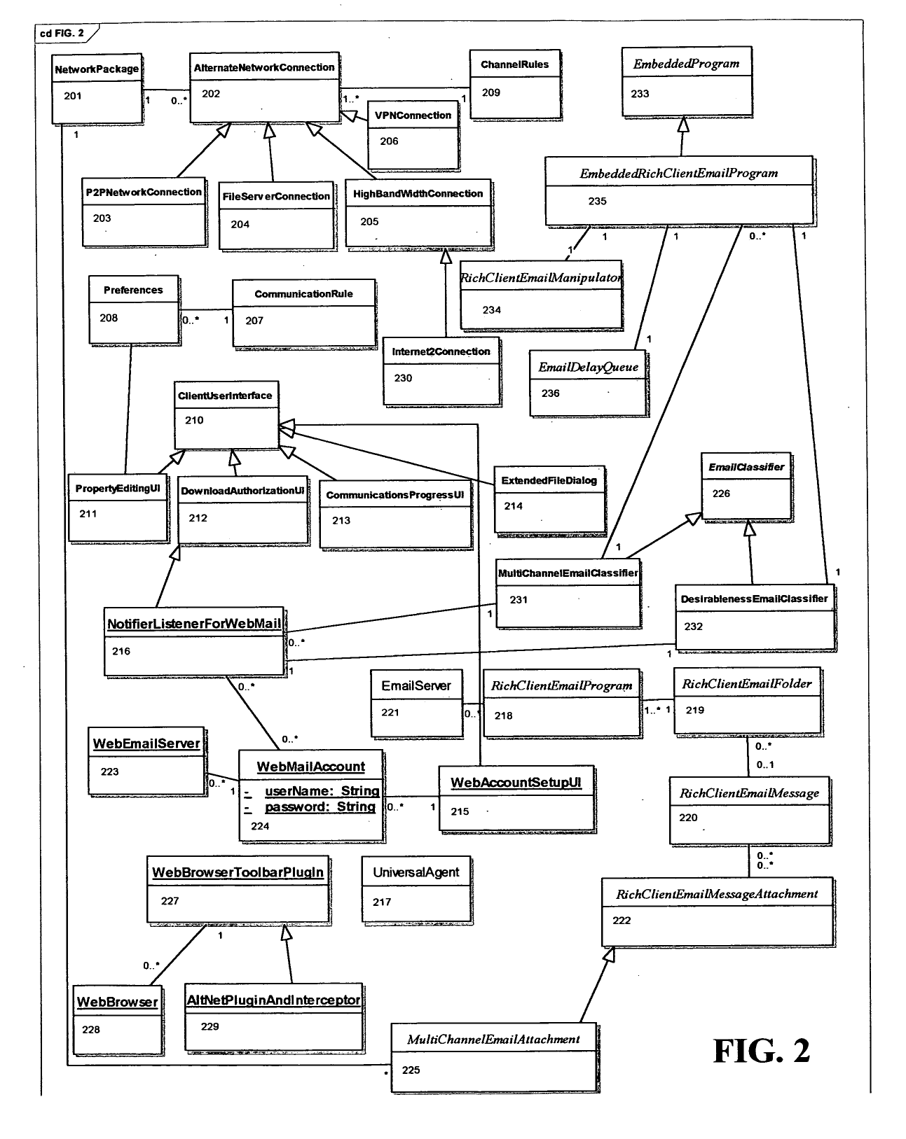

FIG. 2 depicts a class diagram illustrating the architecture of a system according to an embodiment of the invention. The elements of this diagram all support the automated sending and receiving of content via email where the content may or may not all travel according to the normal email conventions, employing the normal email infrastructure but instead may use a range of other approaches to the sending and receiving of information. Italicized classes represent the classes that would participate primarily in the rich-client implementation and underlined boxes represent those classes that would participate primarily in the thin-client, browser-based implementation.

A system according to an embodiment of the invention could support one or more types of AlternateNetworkConnections 202. Possibilities include a swarming Peer-to-PeerNetworkConnection 203, such as one implemented with BitTorrent, or related peer-to-peer swarming technologies, shared FileServerConnections 204 onto which attachments can be placed, HighBandWidthConnections 205, including Internet2Connections 230. A Virtual Private Network VPNConnection 206 could also be an AlternateNetworkConnection 202.

The ChannelRules 209 contain the capability for selecting which elements of an email, including but not limited to attachments, should be sent over conventional email infrastructure and which elements should be sent via an AlternateNetworkConnection 202. For example, a rule could simply state that if an email attachment is larger than 10 megabytes, it should be transferred over a BitTorrent swarming peer-to-peer channel.

A NetworkPackage 201 is an element that represents the part of the email message that has been sent via an alternative method. This network package could be a file, a URL, an ID number, a marker, or a link to content available elsewhere.

CommunicationRules 207 specify the user's preferences about what content should be blocked, downloaded automatically and downloaded only after explicit user authorization. ClientUserInterfaces 210, including PropertyEditingUI 211, can set user Preferences 208, including the CommunicationRules 207. DownloadAuthorizationUI 212 is a UI that the system can use to request authorization from the user to retrieve a specific content element, such as an attached file. The CommunicationsProgressUI 213 shares with the user information about the progress of communication, perhaps including what has been sent from the local machine and what has been retrieved by a receiving machine, as well as what has been sent from other machines and received by the sending machine. An ExtendedFileDialog 214 can be used to allow the user to select files and directories. This user interface may package the selected files into a NetworkPackage 201, which is a marker or identifier that can be sent along with the conventional email message.

The WebAccountSetupUI 215 can perform the function of capturing account information, including the username and passwords, for any number of different web mail accounts that, thereafter, can be accessed. This information can be stored inside WebMailAccount objects 224. NotifierListenerForWebMail 216 is a DownloadAuthorizationUI 212 that checks the websites for new mail and notifies the user when new mail has arrived. NotifierListenerForWebMail 216 uses the WebMailAccount objects 224 to obtain the usernames and passwords. NotifierListenerForWebMail 216 can initiate download of content from an AlternateNetworkConnection 202.

The DownloadAuthorizationUI 212 can be used with a thin-client, web-based version of a system according to an embodiment of the invention. DownloadAuthorizationUI 212 can cycle though the WebMailAccount objects 224, determining if the user has unread email on any of the accounts represented. If the user does, these emails can be checked for multi-channel content via the MultiChannelEmailClassifier 231. The user can be asked by the MultiChannelEmailClassifier 231 if this download should be started immediately even before the email is read. Alternatively, the system can apply the DesirablenessEmailClassifier 232 to determine if this content should be retrieved without asking the user to express an interest in initiating the download. DesirablenessEmailClassifier 232 can be configured to know what content the user has expressed an interest in getting immediately. Both of these classifiers can be types of EmailClassifiers 226, an abstract class of objects for classifying emails.

Some elements of a system according to an embodiment of the invention can be used in a thin-client, browser-based context. A WebBrowserToolbarPlugin 227 could be supplied that works inside a particular WebBrowser 228. A toolbar AltNetPluginAndInterceptor 229 can intercept HTML code that comes from a WebEmailServer 223 website (such as Yahoo mail, Google's gmail site, Hotmail, etc.) and insert code that will permit an ExtendedFileDialog 214 to open when the user clicks a particular button. It can also invoke facilities such as PropertyEditingUI 211.

Some elements of a system according to an embodiment of the invention can be used in a rich-client, plug-in-based context. For example, EmbeddedPrograms 233 are programs that run inside other existing, often widely distributed systems. These are sometimes referred to as “plug-ins”. EmbeddedRichClientEmailProgram 235 is a module that can run inside of a RichClientEmailProgram 218, such as Microsoft Outlook, etc. It could contain a specialist RichClientEmailManipulator 234 object for manipulating rich-client emails. For example, RichClientEmailManipulator 234 could contain methods for adding and removing attachments or for adding comments to the bottom of an email. EmbeddedRichClientEmailProgram 235 generally can contain any number of RichClientEmailFolders 219, which are the visible containers used for storing emails in many rich-client email applications.

EmbeddedRichClientEmailProgram 235 may optionally contain an EmailDelayQueue 236 where content can be stored while messages are being assembled from parts transmitted over multiple channels.

The UniversalAgent 217 can be used to access both the capabilities of the AlternateNetworkConnection 202 as well as special services like file selection by the user via the ExtendedFileDialog 214.

RichClientEmailProgram 218 can be associated with any number of EmailServers 221. These servers can contain a number of folders for holding incoming and outgoing RichClientEmailMessages 220. These, in turn, may have RichClientEmailMessageAttachments 222, which may or may not be MultiChannelEmailAttachments 225, containing NetworkPackages 201.

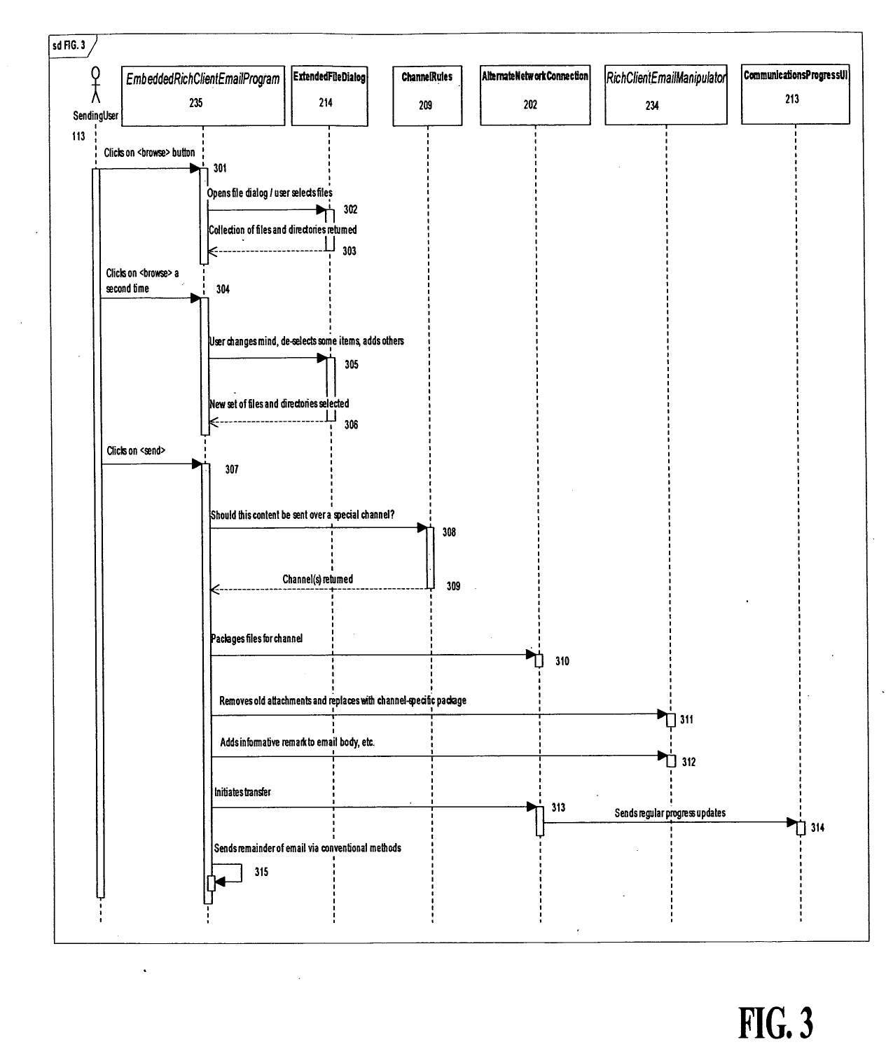

FIG. 3 depicts a sequence diagram illustrating a rich client sending an email attachment via a file browser, according to an embodiment of the invention. In this embodiment, a user clicking on the browse button 301 in a conventional rich email client where a system according to an embodiment of the invention has been installed can send a file or files via an AlternateNetworkConnection 202. A clicking action 301 in the EmbeddedRichClientEmailProgram 235 brings up 302 an ExtendedFileDialog 214, which returns a representation of the files and directories that have been selected for sending 303. If the user changes his or her mind and clicks “browse” a second time 304, the ExtendedFileDialog 214 is brought up 305 again. Some files and directories are added and others are removed 306. When the user clicks send 307, a querying 308 of the ChannelRules 209 occurs, which determines 309, perhaps based on the size of the attachments or other attributes, if the attachments should be sent over one or another of the AlternateNetworkConnections 202. Next, the files and directories are packaged 310 by the appropriate AlternateNetworkConnections 202, as recommended by the result of the message 308. Note that the packaging can be done at the point of selection, at the point of sending or at another time, according to an embodiment of the invention. Next, the attachments are removed 311 by the specialist RichClientEmailManipulator 234 and a Network Package 201 is put in its place. Informative remarks can be added 312 to the email, possibly in the body portion. Next, the transfer is initiated 313 and information about the progress can be reflected 314 in the CommuncationsProgressUI 213. Lastly, the remaining email content is sent 315 in the conventional way.

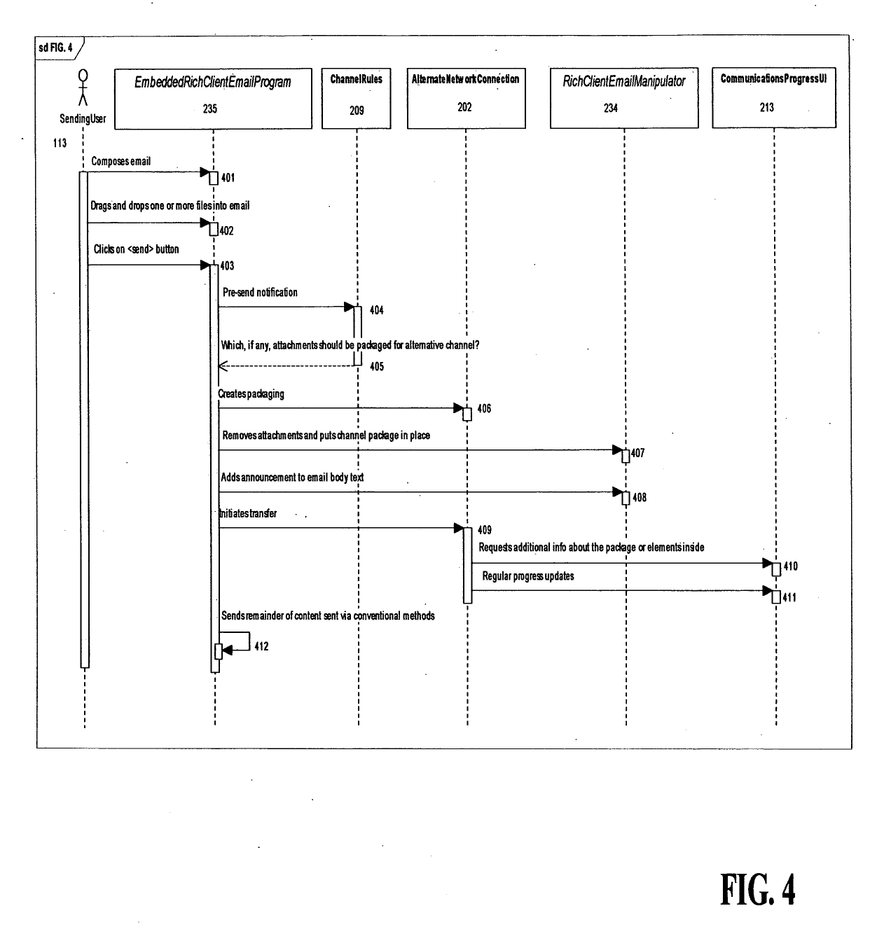

FIG. 4 depicts a sequence diagram of a rich-client email sending an attachment via drag and drop, according to an embodiment of the invention. The SendingUser 113 begins composing 401 an email and, while editing, drags 402 a file into the message body, continues to add more text and eventually clicks 403 on the <send> button. The ChannelRules 209 are consulted 404 to determine which, if any, of the files should be converted into packages for sending via an AlternateNetworkConnection 202. Here, as in FIG. 3, the rules can determine the channel depending on the size or any other attribute of the attached elements. The rules return 405 information about which channels are appropriate, and those channels are used 406 to create packages for the elements of content, which are transmitted to the AlternateNetworkConnection 202. Then AlternateNetworkConnection 202 removes the attachments that will travel via an alternative channel and puts the packages in place 407. The packages are sent to the RichClientEmailManipulator 234 to await transfer. Now, the EmbeddedRichEmailClientProgram 235 initiates transfer of the packages 409. When sending large files, regular update messages can be sent 411 by the CommunicationsProgressUI 213 to the sender's user interface to reflect the transmission progress. Other elements of the email that are not sent via an alternative channel are sent 412 via the conventional mail methods.

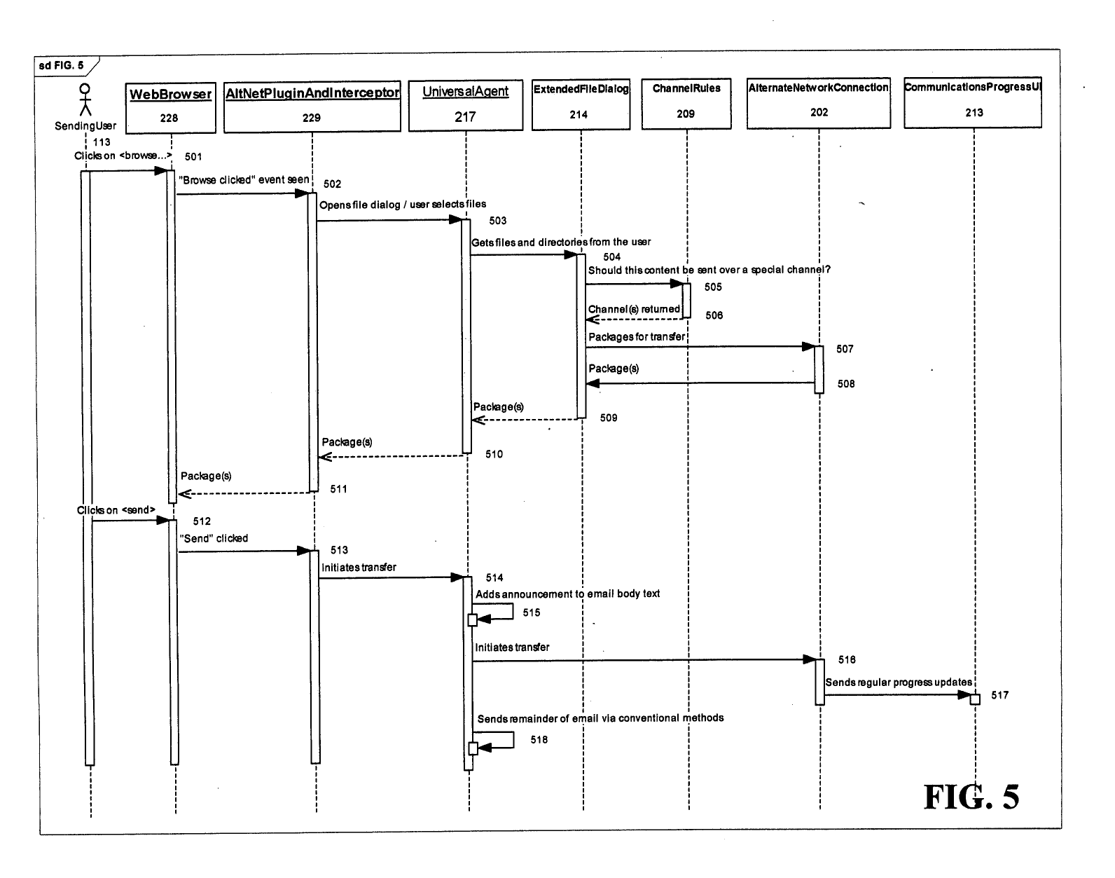

FIG. 5 depicts a sequence diagram illustrating a thin client sending an email attachment via a file browser, according to an embodiment of the invention. In this embodiment, a user can click on the file browse button 501 on a web email site to enable the sending of a file or files via an AlternateNetworkConnection 202. This case is analogous to the case depicted in FIG. 3 except that it is designed to work with a browser-based user interface to a web email system. A clicking action 501 is identified 502 by the AltNetPlugInAndInterceptor 229, which is passed along to the UniversalAgent 217. The UniversalAgent 217 invokes 503 the ExtendedFileDialog 214 and retrieves 504 files or directories from the user's computer. The dialog 214 invokes 505 the ChannelRules 209 to determine 505 if the files are packaged specially for transfer and, if so, by which alternative channel. ChannelRules 209 returns 506 information about which network to use. The ExtendedFileDialog 214 requests 507 the files in packaged form. Once the packaging is completed 508, the package or packages are returned 509 to the client agent, returned 510 to the AltNetPlugInAndInterceptor 229, and finally returned 511 to the WebBrowser 228 where the package or packages can be sent to the email website as special files. When the SendingUser 113 clicks <send> 512, the AltNetPluginAndInterceptor 229 identifies 513 and informs 514 the UniversalAgent 217 what has happened 515. Next, transfer is initiated 516 and information about progress can be reflected 517 in the CommuncationsProgressUI 213. Lastly, the remaining email content is sent 518 in the conventional way.

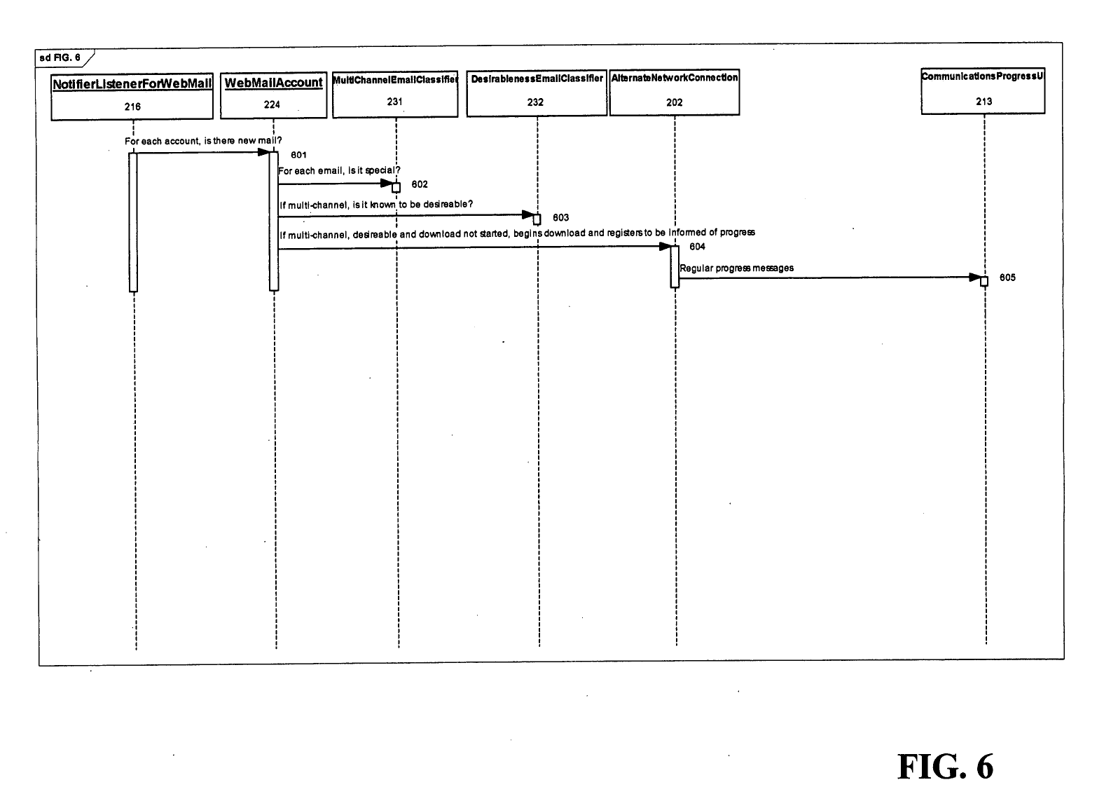

FIG. 6 is a sequence diagram illustrating the actions that occur when a desirable multi-channel email arrives with the use of a thin-client notifier, according to an embodiment of the invention. In this case, the user has employed a web email service, such as Yahoo, Google's gmail, Hotmail, etc. The user has also activated a notification service to be both informed of the existence of new mail for any number of email accounts on any number of email providers, and to automatically initiate the download of large files in the manner discussed herein.

Periodically, according to parameters set up by the user, the NotifierListenerforWebMail 216 queries 601 each WebMailAccount 224 to determine if there is new email. Once new email is found, each email is examined 602 by the MulitChannelEmailClassifier 231 to determine if it is “multi-channel,” meaning that it contains a NetworkPackage 201 for transmission by an alternative channel. If it is multi-channel, it is examined 603 by the DesireablenessEmailClassifier 232 to determine if it is “desirable,” meaning that the user has informed the system that content from this sender should always be fetched. Next, the system checks to see whether the content has already been downloaded or a download has been initiated. If not, fetching is initiated 604 via the AlternateNetworkConnection 202. Regular messages can be sent 605 to the CommunicationsProgressUI 213 to update the user on fetching activity progress.

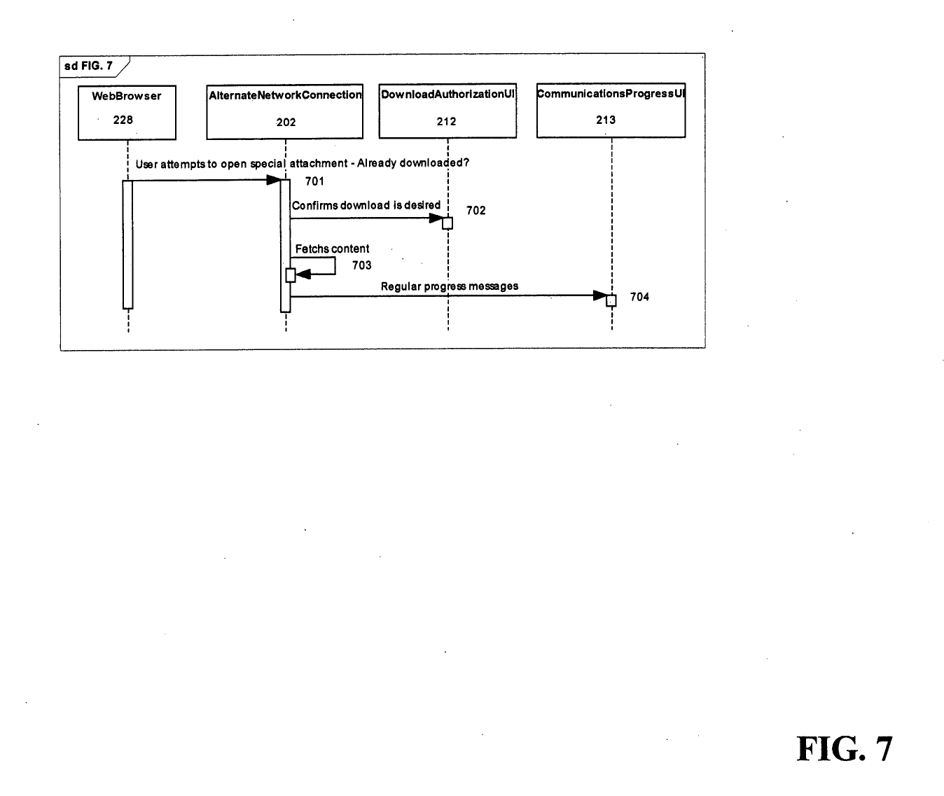

FIG. 7 is a sequence diagram illustrating the arrival of multi-channel non-interesting email in the thin-client context. In this case, the user would be employing a web email service, such as Yahoo, Google's Gmail, Hotmail, etc. to download a file that the system did not consider interesting enough to download automatically. The user attempts to access the file 701 with the WebBrowser 228, which connects to the AlternateNetworkConnection 202 to determine if the file is already local. Once the system determines that the content does not exist locally, download authorization is requested from the user 702 via the DownloadAuthorizationUI 212. AlternateNetworkConnection 202 performs the download 703 and provides 704 the user with information about progress via a CommuncationsProgressUI 213.

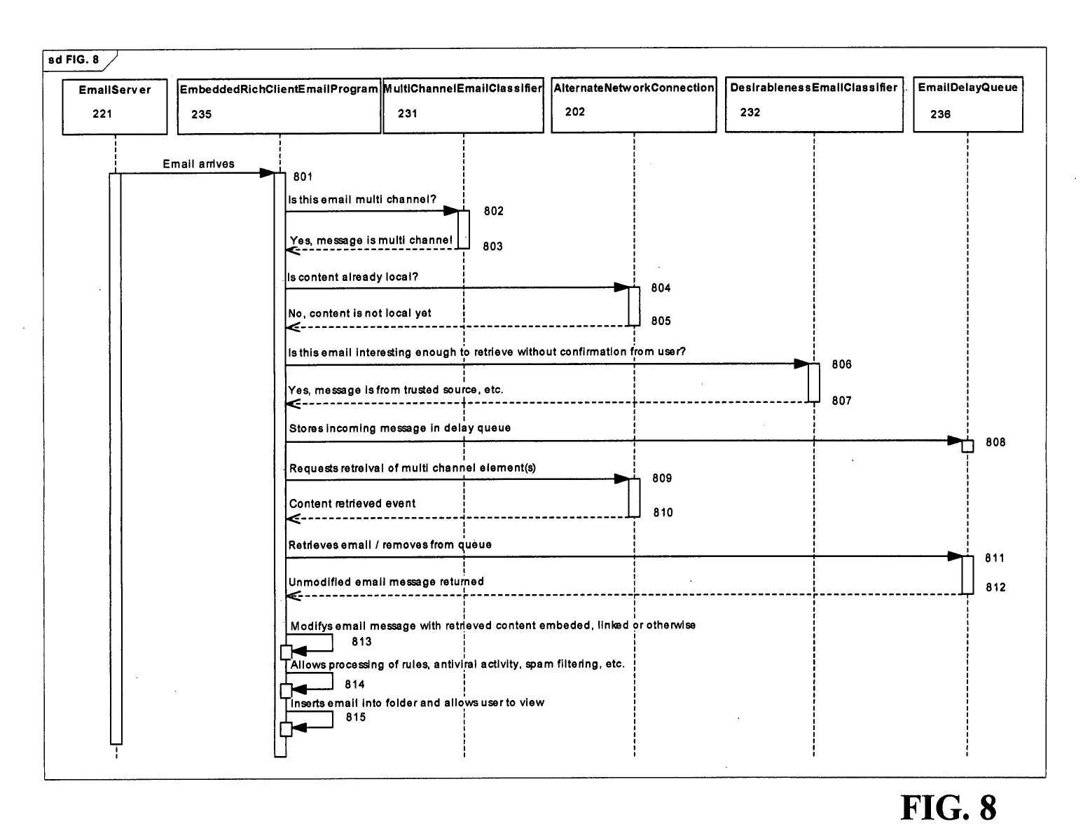

FIG. 8 is a sequence diagram illustrating the actions that occur when a desirable multi-channel email arrives at a rich client. In this case, an incoming email arrives at a rich email client, such as Microsoft Outlook Express, Microsoft Outlook, etc., and has an attachment. This implies that reconstruction of the message will be required and that the message has been determined to be sufficiently relevant to be automatically downloaded without querying the receiving user for authorization to retrieve the content.

The email arrives 801 from the EmailServer 221 into the EmbeddedRichClientEmailProgram 235. The MultiChannelEmailClassifier 231 investigates the email 802, determining that the email contains a payload 803. This indicates that an alternative channel was employed for part of the data transmission. Next, the AlternateNetworkConnection 202 determines 804 whether this content has already been downloaded or is in the process of being downloaded. The AlternateNetworkConnection 202 responds 805 that the content is has not already been downloaded and is not in the process of being downloaded. Next, the DesireablenessEmailClassifier 232 determines 806 whether the user must be asked before this content is retrieved. The DesireablenessEmailClassifier 232 responds 807 that the user has already requested automatic download of this type of content, perhaps by labeling the sender as someone trusted to send only desirable material. Next, the incoming mail message is stored 808 in an EmailDelayQueue 236. Then the EmbeddedRichClientEmailProgram 235 retrieves 809 the content from the appropriate AlternateNetworkConnection 202. After the content has been retrieved 810, the unmodified email message is pulled 811 from the EmailDelayQueue 236 and returned 812 for processing. This includes modifying 813 the message to remove the indicator file or tags and replacing them with the new attachments or links to the downloaded content. Next, email rules and antiviral checking 814 is executed. Last, the email is made visible 815 as a content element in an email folder or similar construct inside the EmbeddedRichClientEmailProgram 235.

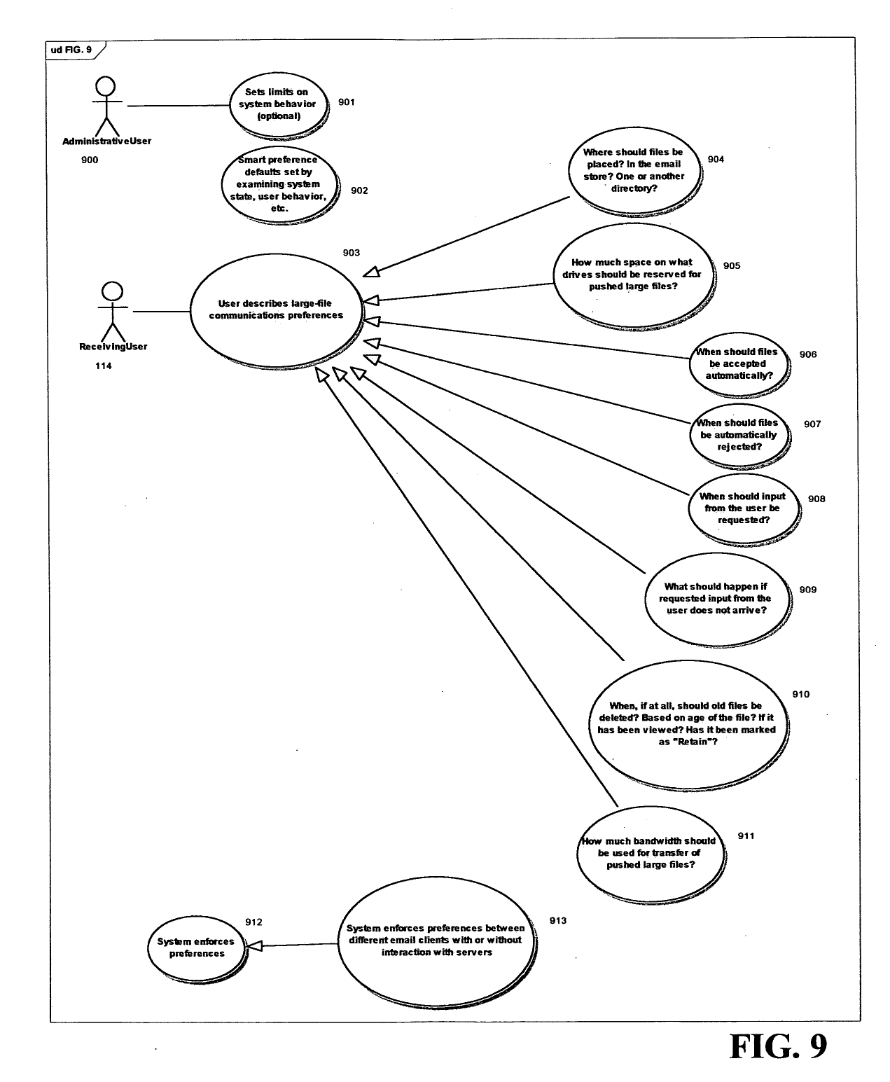

FIG. 9 is a use case illustrating an automated large-file communications management system, according to an embodiment of the invention. A robot or an independent agent can capture and enforce the user's preferences regarding large files management on the local storage devices, including disk drives. This allows the user to set aside a sufficient amount of space that is dedicated to storing content that may arrive from the alternative channels. The user can further configure by defining rules for the acquisition, storage and retention of the content. For example, content received from certain trusted sources can automatically be saved without user intervention. Content from less trusted sources can only be saved upon intervention from the user. Content from other sources might be automatically blocked without intervention from the user. In addition to the sender's identity, rules could consider the size of the file, the type of the file, the topic of the file, and any other related information. The user can define further rules for the retention of the content, including preferentially retaining or deleting depending on size of content, if it has or has not been viewed, the source of the content, the subject matter of the content, the need for space, etc. A hierarchy of priorities for deleting content when the available storage space is insufficient for new incoming content can be defined. Rules could also be defined to set priorities of uploads and downloads, so that, for example, users could ensure that they will not be waiting for a small file to arrive while large files are using up the available bandwidth.

For example, an AdministrativeUser 900 can set 901 outer boundaries on those storage management parameters that less privileged users are permitted to modify. In addition, the system, perhaps at install time, can examine 902 the amount of storage space available, how it is used, who is using it, where the storage space is, how quickly information on those devices can be accessed, etc., and set defaults for how the automated file management system will behave. Next, a Receiving User 114 can override 903 these defaults with explicit settings. For example, the Receiving User 114 could override the defaults with information about where files should be stored 904, how much space should be allocated 905, when files should be auto-downloaded without action by the user 906, when a file should be automatically rejected 907, when the Receiving User 114 should be asked 908 to provide direction to the system in the absence of any other specific input 909, when should files that have been downloaded be disposed of 910, and how much of other limited resources, such as bandwidth, should be allocated to the transfer of large files 911. The system can enforce 912 the user's preferences. It can do this with content that is sent via the conventional email channel, with content sent via alternative channels, or with content sent via a combination of both 913.

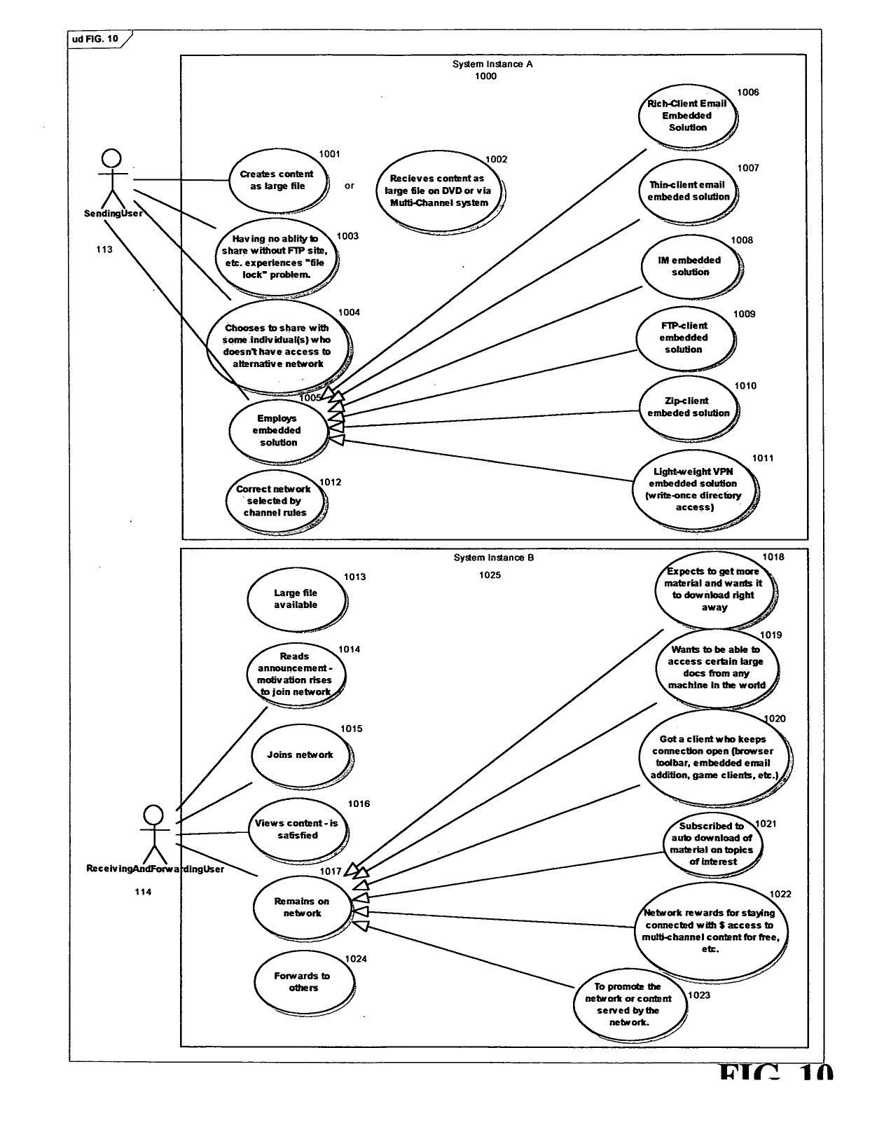

FIG. 10 depicts a use case illustrating viral marketing as a result of “large file lock”. Users of computers may find themselves wishing to share large files that they have on their machines, such as an edited video file. Many users, particularly consumer users of computers, may not have access to streaming servers, FTP sites or other convenient methods for transmission of these large files. This desire to share large files while lacking a rapid, inexpensive means of doing so is here called “large file lock”. SendingUser 113, using System Instance A 1000, creates content 1001 or receives content 1002. The user determines that she or he wishes to share the content but has no convenient way to do so 1003. This user chooses to share, using a system according to an embodiment of the invention, with one or more individuals who do not already use such a system 1004. This sharing can be done with an embedded program 1005 inside a rich-client email 1006, thin-client email 1007, Instant Messenger (IM) program 1008, File Transfer Protocol (FTP) client 1009, Zip client 1010, Virtual Private Network client (VPN) 1011, etc. Finally, ChannelRules 209 selects the correct network 1012 and the file is sent. ReceivingAndForwardingUser 114 and others using System Instance B 1025, who are offered the content 1013 learn that, to get the content, they must join a network 1014. They join 1015 the network, view 1016 the content and possibly pass 1024 it along to others. They remain on the network 1017 for several reasons including: they want to receive 1018 more material that they can automatically download, they want to serve 1019 files from their machines, they want to be able to access large files from around the world 1019, they are using a client program that keeps the user on the network 1020, they subscribe to auto downloads of content 1021, they want to receive explicit rewards 1022 such as money, or they want to promote 1023 the network or content the network provides. The ReceivingAndForwardingUser 114 forwards content onto other users, who forward to other users, creating a viral marketing effect

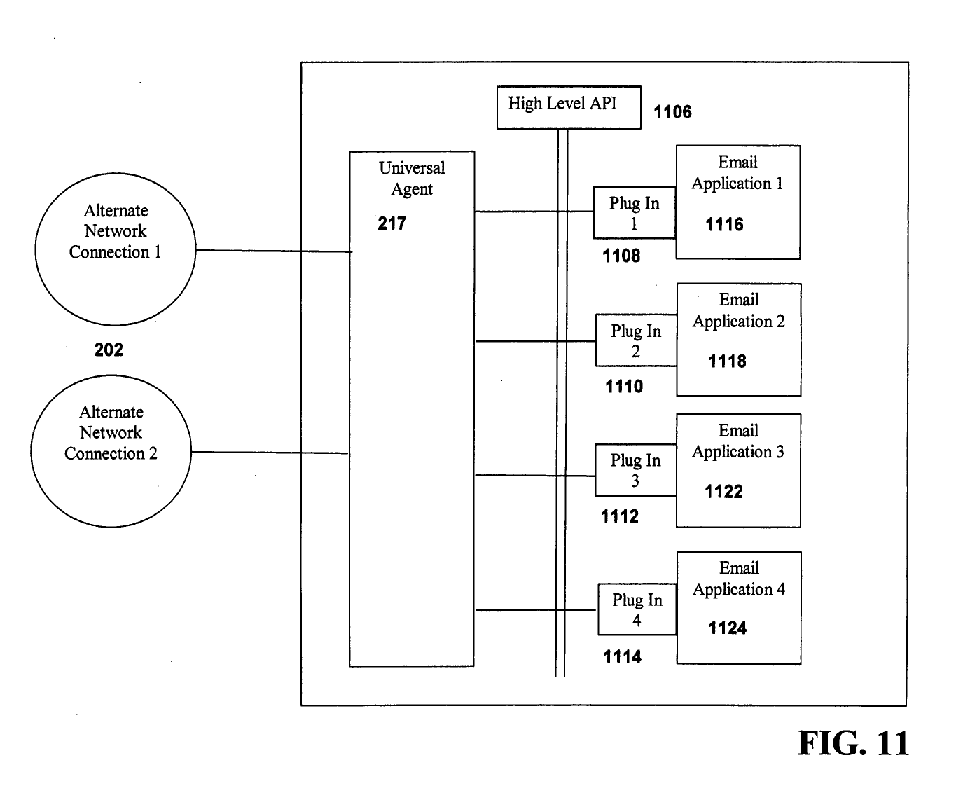

FIG. 11 is a diagram illustrating the architecture of a system for sending email content according to an embodiment of the present invention. More particularly, the diagram illustrates how an existing client email program becomes part of a larger module, exposing a new Application Programmer Interface (API). This allows a single Universal Agent 217 client program to service the extended needs of many different email clients. In order to support multi-channel email communication, these existing client programs will need to access the services of one or more Alternate Network Connections 202. Each of these clients may be different from the others, so no single piece of software could augment all of them with multi-channel email capabilities. For this reason, existing email programs 1116, 1118, 1122, 1124, such as Microsoft Outlook or Outlook Express, are each provided with their own specialized plug-in 1108, 1110, 1112, 1114. These plug-ins can represent specific instances of EmbeddedRichClientEmailProgram 235 seen in FIG. 2. The plug-in supplies and implements a high-level API 1106. The existing email programs 1116, 1118, 1122, 1124, can access the services of the Alternate Network Connections 202 by sending a call through their respective plug-in 1108, 1110, 1112, 1114, which accesses shared capabilities implemented in the Universal Agent 217, which in turn accesses the AlternateNetworkConnection 202. Likewise, the Universal Agent 217 can access the email applications via a high-level API 1106.

Operations supported by the API are included in Appendix 1.

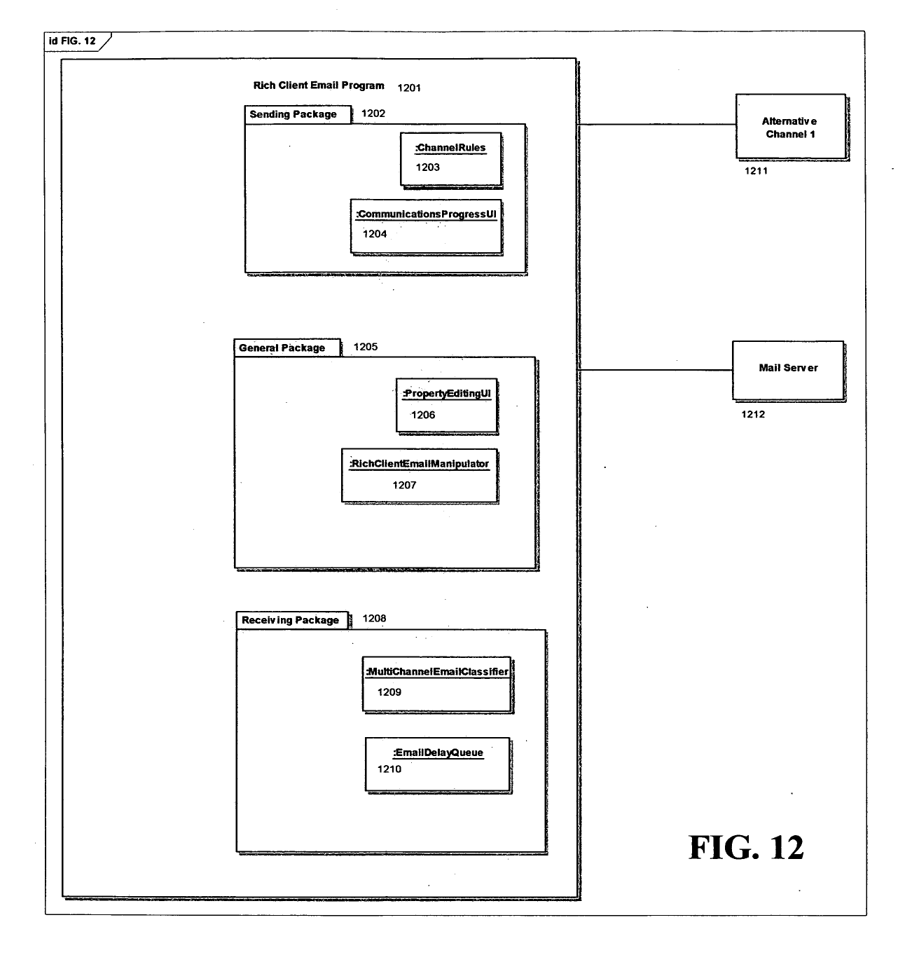

FIG. 12 depicts the architecture of an embodiment of an embedded multi-channel email communication system in which the features described herein above are embedded in a Rich Client Email Program 1201, either as a plug-in or as part of the core of a new email client. These features could come as several packages that can include a Sending Package 1202, ChannelRules 1203 and a CommunicationsProgressUI 1204. These features can also include a General Package 1205 with such features as a PropertyEditingUI 1206, a RichClientEmailManipulator 1207, and a Receiving Package 1208, which could also include a MultiChannelEmailClassifier 1209 and an EmailDelayQueue 1210. In this embodiment, the new functionality is embedded in the client program and this new functionality talks both to the new channels, depicted as Alternative Channel 1 1211 and to the traditional Mail Server 1212, such as Microsoft Exchange or a POP-SMTP server.

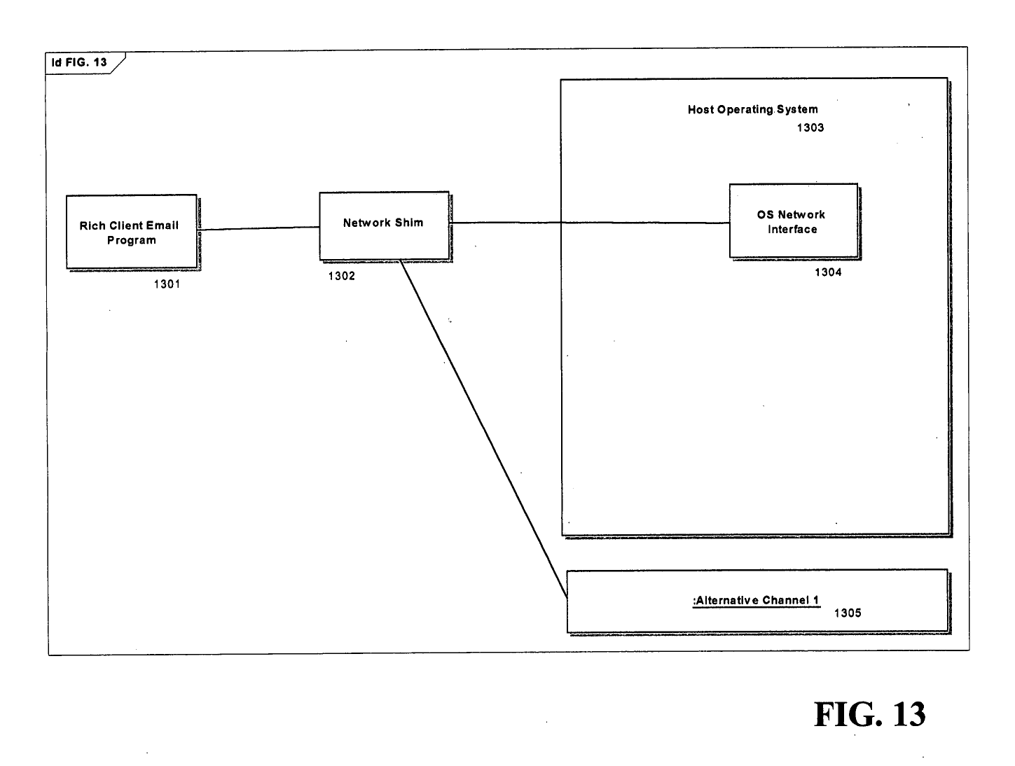

FIG. 13 depicts the components of an implementation of a network shim multi-channel email communication, according to an embodiment of the invention. In this embodiment, the packaging of the attachment and the sending via an alternative channel can be performed at the level of network calls. The Rich Client Email Program 1301 can run nearly unmodified or completely unmodified. It can make normal network calls to a substitute for the normal operating system module that would conventionally receive such calls. This Network Shim 1302 can perform such functions as, for example, selection of the alternative channel, sending of the information along the Alternative Channel 1 1305, as well as sending along the traditional channel, via the OS Network Interface 1304. One or both of these functions can employ the Host Operating System's 1303 conventional networking API, OS Network Interface 1304. The Network Shim 1302 can be situated between the Rich Client Email Program 1301 and Host Operating System 1303 or it can be installed into the Host Operating System 1303 where it can intercept all network calls made by any application. The Network Shim 1302 can, situated either outside or inside the operating system, detect Rich Client Email Program 1301's use of email protocols and invoke operations on one or more alternative channels instead.

Alternative Channel 1 1305 can also employ the OS Network Interface 1304 in order to communicate via the relevant alternative channel.

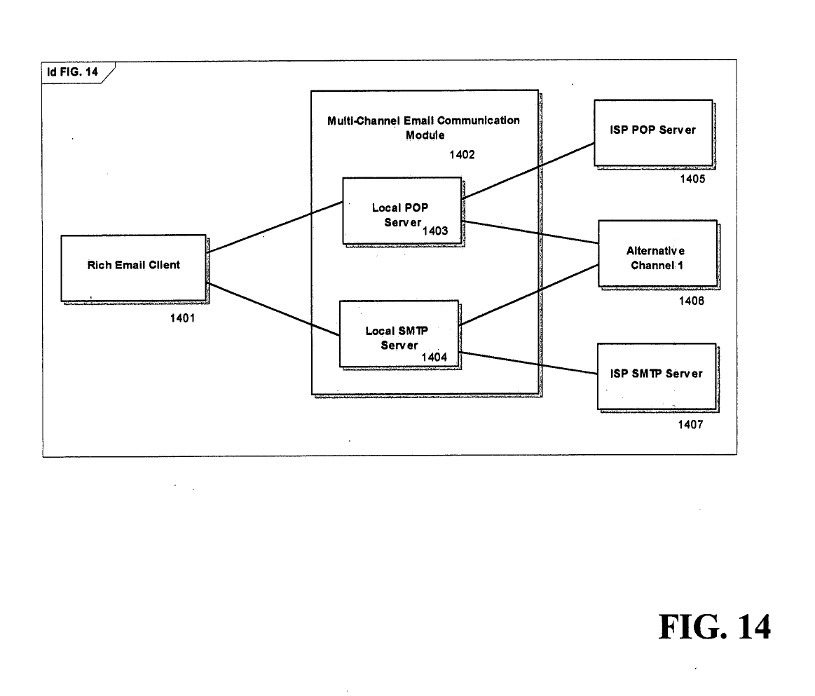

FIG. 14 depicts the components diagram of a local POP and SMTP implementation, according to an embodiment of the invention. In this embodiment, a traditional Rich Email Client 1401 can be redirected, either automatically or manually, to employ a different Local POP Server 1403 and/or a different Local SMTP Server 1404, perhaps running on the local client machine. This redirection could be performed once when a system according to an embodiment of the invention is being installed on a client machine. Alternatively, a Multi-Channel Email Communication Module 1402 could implement other standard protocols besides or in addition to SMTP and POP. This Multi-Channel Email Communication Module 1402 and its components can perform such functions as, for example, selection of the alternative channels for the sending of the information and repackaging it for sending along an Alternative Channel 1 1406. Multi-Channel Email Communication Module 1402 can also handle the reverse operation of replacing marker attachments with the real attachments that have come through via alternative channels. The ISP POP Server 1405 and the ISP SMTP Server 1407 are the real POP and SMTP servers that the Rich Email Client 1401 would be employing before the system according to an embodiment of the invention was installed.

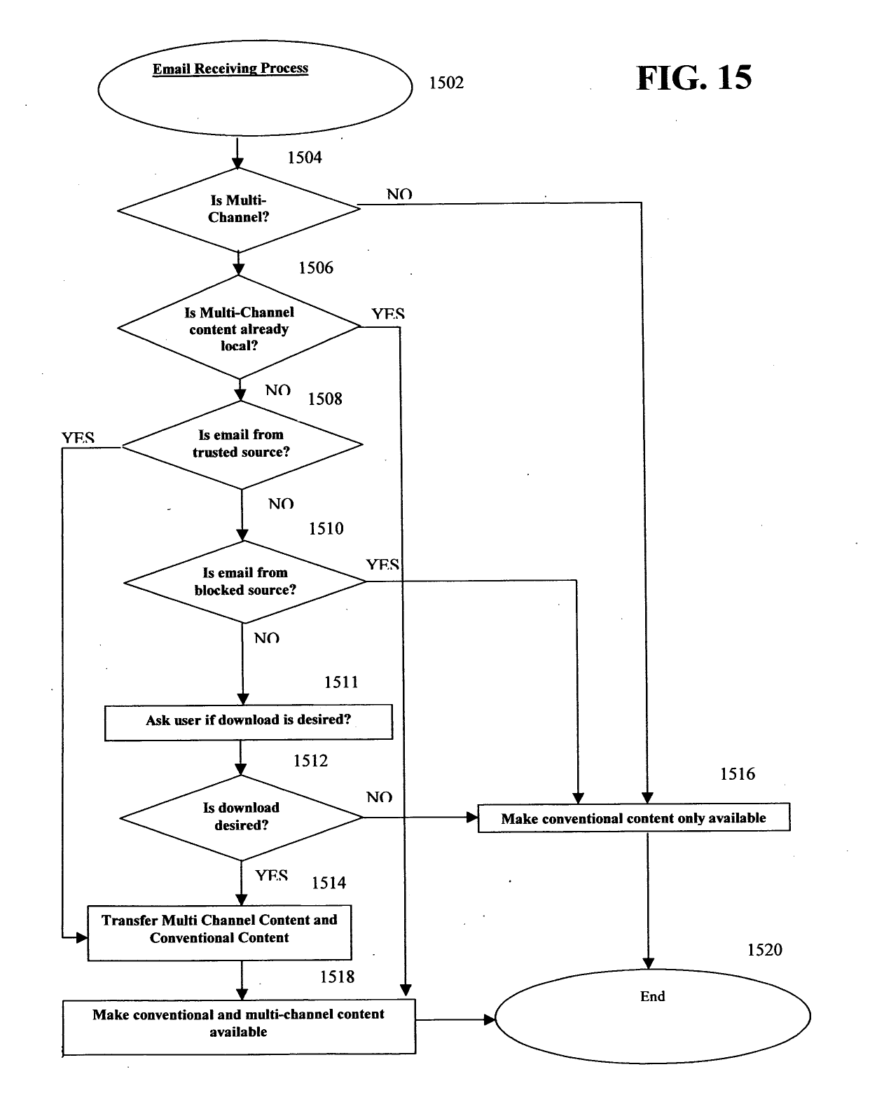

FIG. 15 is a flow chart illustrating the process of receiving email in either the rich or thin client embodiments, according to an embodiment of the invention. When a new email arrives 1502, the system determines 1504 if the email contains multi-channel content. If not, the email is made user-available 1516 according to traditional methods. If it is multi-channel and the content is 1506 already local, only the conventional email content is made user-available 1516 according to traditional methods. If it is multi-channel and the content is not already local 1506, then the system checks to see if it is desirable, for example, if it is from a trusted source 1508. If it is from a trusted source, it can be downloaded immediately, without user intervention 1514. Otherwise, if the content is not from a trusted source, the system checks if it is from a blocked source 1510. If it is, only the conventional email content is made user-available 1516 according to traditional methods. If it is not from a blocked source, then the system asks whether the user wants to download the multi-channel content 1511. If the user only wants to the download the conventional elements of the email, but not the multi-channel elements, then only the conventional email content is made user-available 1516 according to traditional methods. If the user wants to download conventional and multi-channel elements, then both elements are downloaded 1514 and made user-available 1518, and the process is completed 1520.

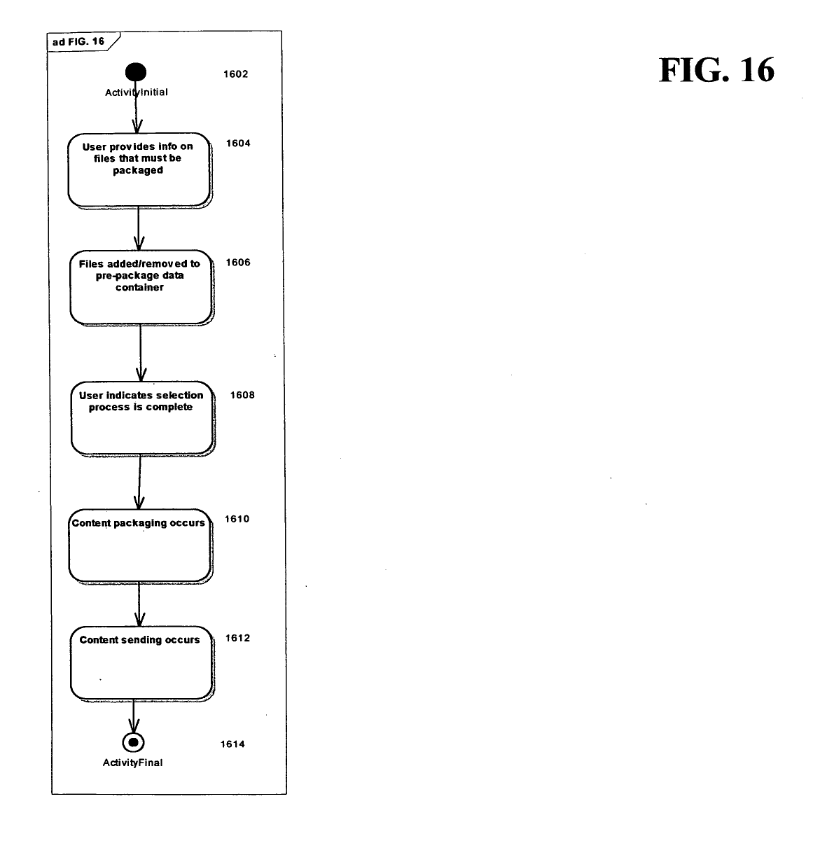

FIG. 16 is a flow chart illustrating multi-step attach activity, according to an embodiment of the invention. The creation of a Network Package 201 may be resource-intensive, for example, consuming much time. Various methods can be employed to make the process less bothersome for the end user. For example, the information needed for packaging of large files can be pre-computed on the user's local data store in case the user wishes to send that file to others, possibly in a background, low-priority process or thread. Alternatively, the creation of the NetworkPackage 201 can be delayed until some other time-consuming activity is initiated or until the system is performing asynchronous activities in the background.

A user expresses interest in creating a package of content to be sent along with an email or other communication 1602. The user selects 1604 content, possibly files, to be sent along with the main communication. The user can select files by using a file selection dialog, by dragging and dropping files, by clicking on files in a file browser, by typing the name of a file, etc. Instead of immediately packaging the files for transfer, the information about the files is retained 1606 in an intermediate form, such as a simple text file containing the path names to the files. After the user is finished selecting files 1608, the intermediate form is converted 1610 into the NetworkPackage 201, perhaps while execution of an email send or other asynchronous activity is taking place. This enables the actual communication of the information 1612 and the process completes 1614. In the case of a peer-to-peer swarming network, creation of the NetworkPackage 201 can involve the creation of a Torrent file. This can involve such activities as computing the SHA1Hash of each of the files to be sent and storing the hash values into the NetworkPackage 201.

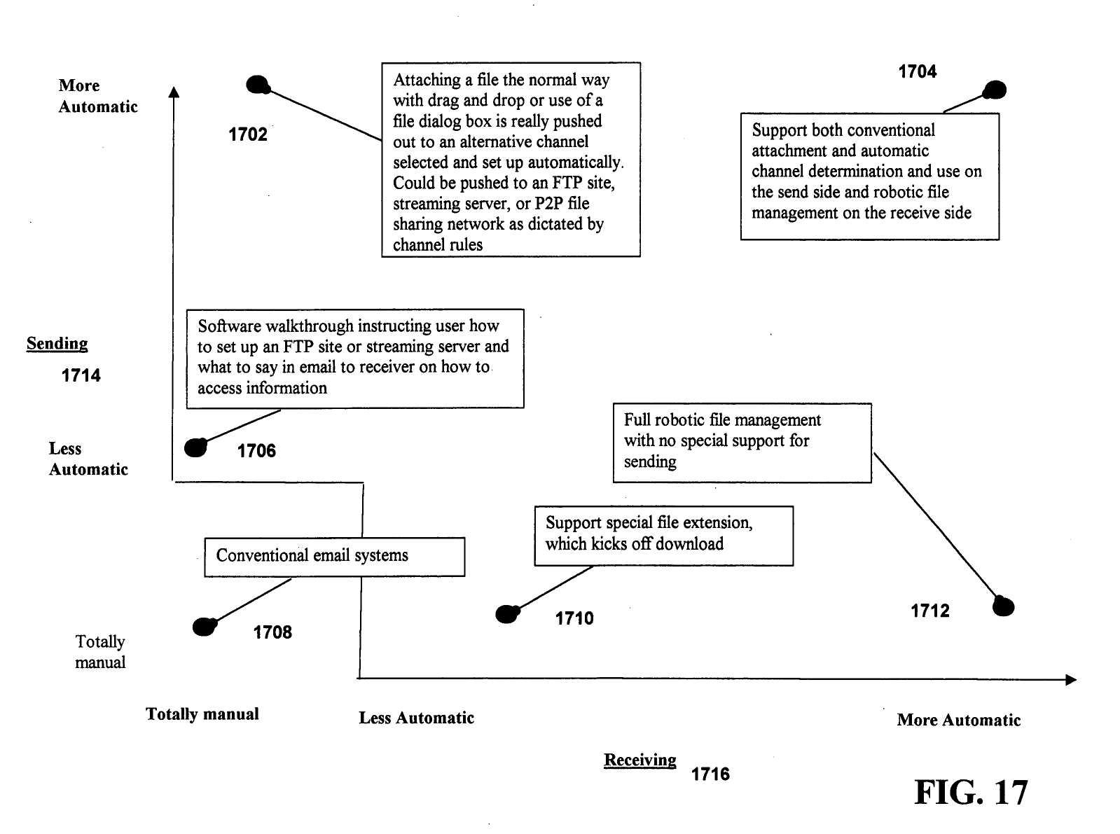

FIG. 17 is a schematic diagram of an automation scatter plot, illustrating that automation of multi-channel communication can occur at many different levels. Current email systems are extremely manual in their handling of attachments and the management of large attachments in particular. This diagram illustrates various levels of automation, all of which are beyond what is supported by conventional email systems, represented by the lower left portion of the diagram, 1708.

In one embodiment of the invention 1702, one could have a high level of automation for sending and a low level of automation for receiving. A sender could attach a file via conventional methods, such as drag-and-drop, or selecting from a file dialog box. The actual transmission, however, is performed via an alternative channel and employed automatically, either via an FTP site, streaming server, or swarming peer-to-peer file-sharing network, as directed by channel rules. There could be a high level of automation on both the sending and receiving sides as in 1704, which involves supporting both conventional attachment and automatic channel determination and use on the send side and automated file management on the receive side. There could be support for a moderate amount of sophistication on the sending side and very little automation on the receiving side as in 1706 where the software walks the user through setting up an FTP site or streaming server and tells the sender what to say in the body of the email to the receiver to access the information. A moderate amount of support for receiving with little automation on the sending side 1710 might involve supporting a special file extension that starts a download when the user clicks on it. There could be a high level of support for receiving but no special support for sending as in 1712 where full, automated file management is provided but with no special support for sending. Automation support can exist to support sending 1714 and/or receiving 1716. Conventional email systems automate neither sending nor receiving 1708.

What is claimed is:

1. A method of sending content via email, said method comprising the steps of:
creating an email message;
obtaining a list of files and directories;
selecting one or more files or directories to send as attachments;
determining an appropriate channel by which to send the attachments;
packaging the attachments into a package;
removing the attachment from said email message and replacing said attachment with a link to said package; and
sending the email message to one or more recipients, wherein the package is sent separately from the body of the email message via one or more alternative channels.

2. The method of claim 1, wherein the determination of an appropriate channel is performed by one or more rules.

3. The method of claim 1, wherein the email is sent from a rich email client.

4. The method of claim 1, wherein the email is sent from a thin email client.

5. The method of claim 1, wherein the one or more alternative channels comprise a peer-to-peer swarming network.

6. A method of receiving content via email, said method comprising the steps of:
querying an email account for the arrival of a new email message;
examining a new email message to determine if it is a multi-channel email and if it is a desirable email;
checking, if the email is multi-channel and desirable, if said multi-channel has been downloaded, and if not, downloading said content; and
informing the account owner of the existence of a new email message.

7. The method of claim 5, wherein said email account is configured to download desirable content without requesting a download authorization from said account owner.

8. The method of claim 5, further comprising the step of requesting authorization from the account owner before downloading said content;

9. The method of claim 5, wherein said email is received by a thin client.

10. The method of claim 5, wherein said multi-channel content is received from one or more alternative channels comprising a peer-to-peer swarming network.

11. A method of receiving content via email, said method comprising the steps of:
receiving an email message;
determining whether the email message includes a payload;
determining, if there is a payload, whether the payload has been downloaded and whether the payload is desirable;
downloading, if said payload is desirable and not downloaded, content associated with said payload, wherein said content is received from one or more alternative channels that comprise a peer-to-peer swarming network;
including with said email message attachments or links to said downloaded content; and
making said email message visible in an email account.

12. The method of claim 11, wherein said email is received by a rich client.

13. A program storage device readable by a computer, tangibly embodying a program of instructions executable by the computer to perform the method steps for sending content via email, said method comprising the steps of:
creating an email message;
obtaining a list of files and directories;
selecting one or more files or directories to send as attachments;
determining an appropriate channel by which to send the attachments;
packaging the attachments into a package;
removing the attachment from said email message and replacing said attachment with a link to said package; and
sending the email message to one or more recipients, wherein the package is sent separately from the body of the email message via one or more alternative channels.

14. The computer readable program storage device of claim 13, wherein the determination of an appropriate channel is performed by one or more rules.

15. The computer readable program storage device of claim 13, wherein the email is sent from a rich email client.

16. The computer readable program storage device of claim 13, wherein the email is sent from a thin email client.

17. The computer readable program storage device of claim 13, wherein the one or more alternative channels comprise a peer-to-peer swarming network.

18. A program storage device readable by a computer, tangibly embodying a program of instructions executable by the computer to perform the method steps for receiving content via email, said method comprising the steps of:
querying an email account for the arrival of a new email message;
examining a new email message to determine if it is a multi-channel email and if it is a desirable email;
checking, if the email is multi-channel and desirable, if said multi-channel has been downloaded, and if not, downloading said content; and
informing the account owner of the existence of a new email message.

19. The computer readable program storage device of claim 18, wherein said email account is configured to download desirable content without requesting a download authorization from said account owner.

20. The computer readable program storage device of claim 18, said method further comprising the step of requesting authorization from the account owner before downloading said content;

21. The computer readable program storage device of claim 18, wherein said email is received by a thin client.

22. The computer readable program storage device of claim 18, wherein said multi-channel content is received from one or more alternative channels comprising a peer-to-peer swarming network.

23. A program storage device readable by a computer, tangibly embodying a program of instructions executable by the computer to perform the method steps for receiving content via email, said method comprising the steps of:
receiving an email message;
determining whether the email message includes a payload;
determining, if there is a payload, whether the payload has been downloaded and whether the payload is desirable;
downloading, if said payload is desirable and not downloaded, content associated with said payload, wherein said content is received from one or more alternative channels that comprise a peer-to-peer swarming network;
including with said email message attachments or links to said downloaded content; and
making said email massage visible in an email account.

24. The computer readable program storage device of claim 23, wherein said email is received by a rich client.

25. A method of selling a service comprising the steps of:
receiving an email wherein said email includes a payload indicating associated content that has been sent via an alternative channel;
receiving a notification to join said service in order to receive said associated content;
joining said network; and
receiving said content via said alternative channel.

26. The method of claim 25, wherein joining said network includes the step of receiving software to enable the receipt of said content via said alternative channel.

27. The method of claim 25, wherein the said alternative channel comprises a peer-to-peer swarming network.

28. A system for sending and receiving email content comprising:
a universal client to provide access to a peer to peer swarming network;
a plug-in for an email client; and
an application programmer interface in communication with said plug-in and said universal client wherein said email client can send and receive content via the peer to peer swarming network.

29. The system of claim 28, further comprising a plurality of email clients, each email client having a plug-in, each said plug-in communicating with said universal client via said application programmer interface.

30. A system for sending and receiving email content comprising:
a network shim connectable to a rich email client and to an operating network interface, wherein the network shim adheres to the operating systems networking protocol and wherein said network shim is invoked by said email client when said email client is sending or receiving content via an alternative network channel.

31. The system of claim 30 wherein said alterative network channel comprises a peer-to-peer swarming network.

32. The system of claim 30 wherein the network shim converts a file to be sent via email into a form suitable for transmission over said alternative network.

33. The system of claim 30 wherein the network shim converts a file received over the alternative network from a form suitable for transmission over said alternative network into a form suitable for viewing.

34. A system for sending and receiving email content comprising:
a local server that supports one or more email protocols connectable to a rich email client and to an operating network interface, wherein said local server is invoked by said email client when said email client is sending or receiving content via an alternative network channel.

35. The system of claim 34 wherein said alterative network channel comprises a peer-to-peer swarming network.

36. The system of claim 34 wherein the local server converts a file to be sent via email into a form suitable for transmission over said alternative network.

37. The system of claim 34 wherein the local server converts a file received over the alternative network from a form suitable for transmission over said alternative network into a form suitable for viewing.

38. The system of claim 34 further comprising a separate local server for at least one of said email protocols.

39. A method of managing email content comprising the steps of:
allocating a pre-defined amount of storage space for storing received email content;
receiving email content;
determining if said content should be saved;
determining, if said content should be saved, if there is sufficient storage space for said content; and
storing said content, if there is sufficient storage space.

40. The method of claim 39, further comprising providing one or more rules for determining whether content should be saved.

41. The method of claim 39, further comprising providing one or more rules for determining how long content should be retained, and when content can be deleted.

42. The method of claim 39, further comprising providing one or more rules for determining how to clear storage space, when there is insufficient space for received content.

43. The method of claim 39, further comprising providing a mechanism for a user to specify when received content should be saved, and how storage space should be cleared when there is insufficient space for received content.

44. A program storage device readable by a computer, tangibly embodying a program of instructions executable by the computer to perform the method steps for managing email content, said method comprising the steps of:
allocating a pre-defined amount of storage space for storing received email content;
receiving email content;
determining if said content should be saved;
determining, if said content should be saved, if there is sufficient storage space for said content; and
storing said content, if there is sufficient storage space.

45. The computer readable program storage device of claim 44, the method further comprising providing one or more rules for determining whether content should be saved.

46. The computer readable program storage device of claim 44, the method further comprising providing one or more rules for determining how long content should be retained, and when content can be deleted.

47. The computer readable program storage device of claim 44, the method further comprising providing one or more rules for determining how to clear storage space, when there is insufficient space for received content.

48. The computer readable program storage device of claim 44, the method further comprising providing a mechanism for a user to specify when received content should be saved, and how storage space should be cleared when there is insufficient space for received content.

49. A program storage device readable by a computer, tangibly embodying a program of instructions executable by the computer to perform the method steps for selling a service, said method comprising the steps of:
receiving an email wherein said email includes a payload indicating associated content that has been sent via an alternative channel;
receiving a notification to join said service in order to receive said associated content;
joining said network; and
receiving said content via said alternative channel.

50. The computer readable program storage device of claim 49, wherein joining said network includes the step of receiving software to enable the receipt of said content via said alternative channel.

51. The computer readable program storage device of claim 49, wherein the said alternative channel comprises a peer-to-peer swarming network.
